(19) United States
(12) Patent Application Publication
(10) Pub. No.: US 2006/0073345 A1
(43) Pub. Date: Apr. 6, 2006

(54) Coating separator process for producing the same and electrical and electronic parts including the separator

(76) Inventor: Shinji Naruse, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/519,003

(22) PCT Filed: Jun. 27, 2003
(86) PCT No.: PCT/JP03/08165

§ 371 Date: Dec. 27, 2004

(30) Foreign Application Priority Data
Jun. 28, 2002 (JP) 2002-189696

(51) Int. Cl. B32B 27/00

(52) U.S. Cl. 428/421

(57) ABSTRACT

This invention provides a separator for electrical and electronic parts with a good electrolyte retention, which is coated with at least one substance selected from ionic substances, hydroxyl group-containing substances and silicon compounds.

### TECHNICAL FIELD

This invention relates to a coated separator, process for the production of the same, and electrical and electronic parts in which the same is used.

### BACKGROUND ART

As is symbolized by the recent progress of portable communication equipments, high-speed processors and the like, it is remarkable that electronic equipments have now smaller size and less weight and give higher performance than before. One of elementary techniques that contribute to this tendency is the improvement of electrical and electronic parts in performance. Batteries are no exception; high-performance parts for batteries are being rapidly developed. There is accordingly a growing demand for the development of technology and quality of members, e.g., separator as an interstructure.

For instance, as a variation of alkaline batteries, a cylindrically shaped one is known. This cylindrical alkaline battery is manufactured by winding a separator onto a group of grids. In order to increase battery capacity or to reduce electric resistance, non-woven fabric which is used as a separator needs to have a good electrolyte retention. For this purpose, a separator is preferably composed of fibers which have as small a diameter as possible. In one of known methods to produce such non-woven fabric, water stream is sprayed on a fiber web which contains divisible fibers which comprise polyolefin resin and are divisible with water stream, by which to divide the divisible fibers and thereby produce fibers having a small diameter. This method has a problem that divisible fibers cannot be divided sufficiently, or that a large amount of energy is required so that fibers may be fully divided.

The objective of this invention is to overcome the above-mentioned problem, i.e., to provide a separator which has a good electrolyte retention.

### DISCLOSURE OF INVENTION

In consideration of the above-mentioned situation, the inventors of this invention have made assiduous study with a view to developing a separator which has a high-level electrolyte retention, and, thus, accomplished this invention.

This invention provides a separator for electrical and electronic parts which is coated with at least one substance selected from ionic substances, hydroxyl group-containing substances and silicon compounds.

This invention also provides a process to manufacture a separator as mentioned above, which is characterized by the following steps: at least one substance selected from ionic substances, hydroxyl group-containing substances and silicon compounds is previously dissolved or dispersed in water; subsequently, an uncoated separator is soaked in the resultant solution or dispersion; and then, said separator is dried so that moisture may be evaporated.

This invention further provides electrical and electronic parts such as battery and capacitor wherein a separator of this invention as mentioned above is used.

In the following, the capacitor of this invention, a process to manufacture the same, and the use of said capacitor are explained in more detail.

(Separator)

In this invention, “separator” is defined as a structure to separate conductive members, e.g., electrodes, from each other in electrical and electronic parts such as battery and capacitor, for the purpose of preventing short circuit. Separator is usually employed in the form of paper, non-woven fabric, fine porous film or a composite thereof, which are not restrictive.

As a material for separator, there are often used aramid, polyester, polypropylene, polyethylene, polyphenylene sulfide, fluoroplastic, polyvinyl alcohol, PBO (poly-para-phenylene benzobisoxazole), polyimide, glass, carbon, alumina, natural fiber and natural pulp, since these materials are easy to process into paper, non-woven fabric or fine porous film. There is however no particular restriction on materials insofar as they have higher resistance than electrode or the like in electrical and electronic parts.

(Coated Separator)

In this invention, “coated separator” means a separator whose surface has, adhered thereon, at least one substance selected from ionic substances, hydroxyl group-containing substances and silicon compounds. There is no particular restriction on the amount of said substance adhered, to the extent that pores of separator are not substantially clogged. Generally, however, said amount preferably falls within a range of 0.004-20%, in particular 0.01-15%, in dry weight, based on the weight of uncoated separator. Although uniform coating is desirable, uneven coating causes no problem if only separator functions as such.

There is no restriction on coating methods. In a suitable method, at least one of the above-mentioned substances is dissolved or dispersed in water; subsequently, a separator is soaked in the resultant solution or dispersion; and then, said separator is dried so that moisture may be evaporated. In another method, an uncoated separator is previously integrated with a part before soaked; subsequently, thus assembled whole part is soaked in solution or dispersion; and then, said whole part is dried so that moisture may be evaporated. The condition of the above-mentioned drying is not particularly restricted. Usually, however, drying is preferably conducted at a temperature of 50° C. or higher for one minute or more.

The above-mentioned “part” means an electrical and electronic part such as battery and capacitor. Such parts include both finished articles and semi-finished ones so long as they have a space permeative with the above-mentioned solution.

(Ionic Substances)

“Ionic substances” which are used in this invention mean substances wherein compound-constituting chemical bond contains ionic bond. Concrete examples include calcium carbonate, calcium chloride, anhydrous calcium chloride, calcium oxide, sodium chloride, sodium sulfate, anhydrous sodium sulfate, sodium sulfite, copper sulfate, anhydrous copper sulfate, aluminum sulfate and sodium carboxymethylcellulose, which are not restrictive. Among these, sodium sulfate and anhydrous sodium sulfate are preferable.

(Hydroxyl Group-Containing Substances)

“Hydroxyl group-containing substances” which are used in this invention mean substances which contain a hydroxyl group (—OH) in compound. Concrete examples include alcohols (e.g., ethanol, butanol, etc.), glycols (e.g., ethylene glycol, propylene glycol, etc.) and polysaccharides (e.g., cellulose, starch, etc.), which are not restrictive. Among these, polysaccharides are especially preferable.

(Silicon Compounds)

“Silicon compounds” which are used in this invention mean compounds which contain silicon. Concrete examples include silica gel, silica sol, silica and zeolite, among which silica is especially preferable, although these are not restrictive.

(Heat Treatment)

In this invention, under circumstances, separator is subjected to heat treatment before and/or after coated, for the purpose of further improvement of electrolyte retention. In particular when a heat treatment is conducted after coating, ionic substance, hydroxyl group-containing substance or silicon compound or the like is fixed on separator with the result that electrolyte retention may possibly be remarkably enhanced. There is no strict restriction on temperature of said heat treatment. Generally, however, the temperature is preferably between 100° C. and the melting point of separator-constituting material. Heat treatment may usually be carried out for 1 to 60 minutes.

(Electrolyte Retention)

In this invention, ” electrolyte retention” means the extent to which a separator sucks up a liquid such as electrolyte within a certain period of time. Concretely, it is defined as a value which is calculated according to the following formula (1):
h²η/γt (1)

wherein h denotes the height (mm) to which a liquid is sucked up within a period of t seconds; η denotes the viscosity (mP a S) of said liquid; γ denotes the surface tension (mN/m) of said liquid; and t denotes sucking time (second).

Generally, the electrolyte retention of the coated separator of this invention as shown by the above-mentioned formula (1) is preferably 0.7 μm or more, especially 1 μm or more.

The separator of this invention which has been coated in the afore-mentioned manner has a good electrolyte retention owing to coating, and is quite suitable as a separator panel between conductive members of electrical and electronic parts.

### EXAMPLES

In the following, this invention is explained in more detail by Example and Comparative Example.

(Method for Measurement)

(1) Measurement of the Basis Weight and the Thickness of Sheet:

Measured according to JIS C2111.

(2) Measurement of Sucking Height:

The height to which n-butanol was sucked up within a period of 30 seconds was measured.

At 20° C., n-butanol had a viscosity of 7 (mP a S) and a surface tension of 24.6 (mN/m).

### Example 1

Fibrid of polymetaphenylene isophthalamide was manufactured with a wet type precipitator as mentioned in Japanese Patent Publication No. Sho 52 (1977)-151624. Thus obtained fibrid was treated with a refiner so that drainage rate (Canadian standard freeness) might become 20 ml.

Aramid fiber (Conex®, manufactured by Teijin Limited) was cut to a length of 5 mm to serve as paper stock (aramid flock). This flock had a fineness of 0.8 denier.

Thus prepared stock was mixed with each other in water, and was then made into sheet with TAPPI standard sheet machine (surface area: 625 cm²).

Said sheet was subjected to calendering process with a calendering machine at a roll temperature of 330° C., a roll linear pressure of 100 kgf/cm, and at a rate of 2 m/min.

Thus calender-processed sheet was soaked in a 0.25% aqueous solution of sodium sulfate for one minute, and was then dried in a hot air oven at 150° C. for 30 minutes.

Thus obtained sheet material was measured for main properties and butanol-sucking height. Results are shown in Table 1.

### Comparative Example 1

The steps of Example 1 were repeated up to calendering process, and, then, thus processed sheet was soaked in high purity water for one minute, and was then dried in a hot air oven at 150° C. for 30 minutes.

Thus obtained sheet material was measured for main properties and butanol-sucking height. Results are shown in Table 1.

TABLE 1

| | | Example | Comparative |
|---|---|---|---|
| Properties | Unit | 1 | Example 1 |
| Composition | | | |
| of material | | | |
| Aramid fibrid | Weight % | 10 | 10 |
| Aramid flock | | 90 | 90 |
| Basis weight | g/m² | 10 | 10 |
| Thickness | mm | 0.04 | 0.04 |
| Density | g/cm³ | 0.25 | 0.25 |
| Sucking height | mm | 13 | 8 |
| Liquid retention | μm | 1.6 | 0.6 |
| h²η/γt | | | |

As is seen in the above Table 1, liquid retention is improved when separator is coated in accordance with this invention.

As explained above, a separator which has been coated in accordance with this invention improves in electrolyte retention. When used in electrical and electronic parts, a coated separator of this invention is expected to help said parts to show their original electrical properties without such loss as caused by the insufficient retention or leak of electrolyte.

1. A separator for electrical and electronic parts which is coated with at least one substance selected from ionic substances, hydroxyl group-containing substances and silicon compounds.

2. A separator of claim 1 wherein said ionic substances are selected from calcium carbonate, calcium chloride, anhydrous calcium chloride, calcium oxide, sodium chloride, sodium sulfate, anhydrous sodium sulfate, sodium sulfite, copper sulfate, anhydrous copper sulfate, aluminum sulfate and sodium carboxymethylcellulose.

3. A separator of claim 1 wherein said hydroxyl group-containing substances are selected from alcohols, glycols and polysaccharides.

4. A separator of claim 1 wherein said silicon compounds are selected from silica gel, silica sol, silica and zeolite.

5. A separator of claim 1 which is selected from paper, non-woven fabric, fine porous film and a composite thereof.

6. A separator of claim 1 which is made from a material selected from aramid, polyester, polypropylene, polyethylene, polyphenylene sulfide, fluoroplastic, polyvinyl alcohol, PBO (poly-para-phenylene benzobisoxazole), polyimide, glass, carbon, alumina, natural fiber and natural pulp.

7. A separator of claim 1 which is subjected to heat treatment before and/or after coated.

8. A separator of claim 1 which has a sucking height in a range as shown by the following inequality (2):
0.7<h²η/γt (2)
wherein h denotes the height (mm) to which a liquid is sucked up within a period of t seconds; η denotes the viscosity (mP a S) of said liquid; γ denotes the surface tension (mN/m) of said liquid; and t denotes sucking time (second).

9. A process to manufacture a separator of claim 1 which is characterized by the following steps: at least one substance selected from ionic substances, hydroxyl group-containing substances and silicon compounds is previously dissolved or dispersed in water; subsequently, an uncoated separator is soaked in the resultant solution or dispersion; and then, said separator is dried so that moisture may be evaporated.

10. A process of claim 9 which is characterized by the following steps: an uncoated separator is previously integrated with a part before soaked in a solution; subsequently, thus assembled whole part is soaked in a solution; and then said whole part is dried so that moisture may be evaporated.

11. Electrical and electronic parts wherein a separator of claim 1 is used.
